(19) United States
(12) Patent Application Publication
(10) Pub. No.: US 2026/0354348 A1
(43) Pub. Date: Nov. 12, 2026

(54) Kit for Animals Comprising a Package and a Nutritional Product

(71) Applicants: Ewa Zurkiewicz, Poznan (PL); Grzegorz Matyszkiewicz, Poznan (PL)

(72) Inventors: Ewa Zurkiewicz, Poznan (PL); Grzegorz Matyszkiewicz, Poznan (PL)

(21) Appl. No.: 19/200,421

(22) Filed: May 6, 2025

(51) Int. Cl. A01K 15/02; A01K 5/01

(52) U.S. Cl. CPC A01K 15/025; A01K 5/0114

(57) ABSTRACT

A kit for animals includes a first housing portion comprising a first interior surface and a first opening defining a first compartment animal nutritional product; a second housing portion comprising a second interior surface and a second opening defining a second compartment; an edible animal nutritional product housed within the first compartment; and an inedible animal toy housed within the second compartment; and wherein first housing portion and the second housing portion are detachably coupled to one another in a closed configuration, wherein the first opening and the second opening abut one another when the kit is in a closed configuration to form a continuous chamber, the continuous chamber defining an entire interior volume of the kit.

### TECHNICAL BACKGROUND

The invention relates to a kit for animals comprising a package and a nutritional product.

Nutritional kits for humans are known from the art. In particular, polish patent description PL184126 relates to a kit containing a nutritional product comprising two half-shells with their respective openings connected to each other face to face, wherein at least one of the half-shells may be a vessel for the additive. Whereby one of the half-shells constitutes the edible part of the set and the other half-shell is made of a non-edible material and constitutes the vessel for the additive.

European patent application EP1018302 A1 relates to a hollow confectionery body made of a confectionery mass, in particular a type of chocolate or a chocolate-like mass, comprising a non-edible, thin-walled support shell placed inside the hollow confectionery body with at least two corresponding parts of the support shell, each of which has connecting elements in the area of its edge of the support shell, in which the parts of the carrier shell are detachably connected to each other, at least two confectionery body shells assigned to the parts of the carrier shell, each resting detachably on the outside of its assigned part of the carrier shell, and at least one non-edible separating element that spatially separates the confectionery body shells from each other.

### SUMMARY

The aim of the invention is to provide a kit that would enable pet owners to effectively train their pets and play with them anywhere.

The subject of the invention is a kit for animals comprising a package and a nutritional product, characterized in that the package is essentially egg-shaped and comprises a two-part housing forming at least one chamber containing the animal nutritional product and animal toy.

Preferably, two parts of the housing are connected to each other face-to-face in a detachable manner.

Preferably, the chamber is divided into two compartments by a separating membrane.

Preferably, the separating membrane is made of a material selected from the group consisting of plastic or edible material.

Preferably, each part of the housing is provided with a sealing flange.

Preferably, one compartment contains an animal food product and the other compartment contains a toy.

Preferably, each of the housing parts has a tab for opening or tearing the package.

Preferably, it comprises one chamber.

Preferably, the package is made entirely of inedible material.

Preferably, the animal is selected from the group comprising dogs, cats, rabbits, and rodents.

Preferably, the outer part of the package is covered with a printable material using available technologies.

### BRIEF DESCRIPTION OF DRAWINGS

The invention, together with the above and other objects and advantages, will be best understood from the following detailed description of the preferred embodiment of the invention shown in the accompanying drawings wherein:

FIG. 1 shows a side view of the egg-shaped variant of the package of the kit according to the invention with a visible tab for opening/tearing the package;

FIG. 2 shows a front projection of the kit from FIG. 1;

FIG. 3 shows a cross-sectional view of half of the package from FIG. 1 with the sealing flange visible;

FIG. 4 shows a view of the package from FIG. 1 from below;

FIG. 5 shows a 3D view of the egg-shaped package composed of two half-cells from FIG. 1;

FIG. 6 shows a 3D view of the unfolded package from FIG. 5; and

FIG. 7 shows an overview view of one part of the housing of the kit from FIG. 1 with particular reference to the separation membrane.

### DETAILED DESCRIPTION

The invention provides the following advantages.

The pet industry is currently outdoing itself with a variety of flavors and texture changes in pet food and snacks. The kit, according to the invention, combines a food or snack with a toy, providing both nutrition and entertainment for pets. The kit, according to the invention, combines high-quality nutritional ingredients with a toy that will stimulate the pet's senses and encourage physical activity. The kit, according to the invention, consists of combining a pet food (snack, treat) with a surprise pet toy, placed in an oval-shaped package or other package constituting a closed chamber.

The kit, according to the invention, combines a snack (food, treat) with a toy—thanks to this solution, we can simultaneously use the toy as a tool for training and thus reward the pet with a treat for a job well done. Advantageously, each part of the package is of considerable size and can be a sterile receptacle for our snack, as it is made of food-grade material.

The way the snack or food and the toy are packaged in the kit, according to the invention, offers unlimited distribution possibilities even in places where snacks, food, treats, and, even more so, pet toys could not previously be obtained. The vast majority of shops do not stock pet toys for training or entertaining pets, only snacks and food alone.

In the kit, according to the invention, each of the half compartments of a package, e.g., in the shape of an egg, adhere to each other along the entire length of the edge, giving protection from light for the contents of the package and providing long-term protection for the products inside.

In the kit, according to the invention, the food and the toy are packed in a single package in the form of a resealable compartment consisting of two equal or unequal parts, forming a whole.

In the kit, according to the invention, a toy for the dog or cat is placed in at least one half-chamber of the package or compartment of the package, wherein said toy for the dog or cat in the form of a rope, ball, mouse, chew, bone, fish, etc. made of commonly available materials.

In the kit, according to the invention, the package has been designed in such a way that its parts interlock perfectly to form an airtight box that protects the contents of the packaging from light, providing long-term protection for the products inside.

In the kit, according to the invention, at least one of the compartments for the animal food and/or toy can be sealed with a separating membrane made of foil or other plastic material in order to be able to place a nutritional liquid or edible paste for animals inside, which can be reached after opening the container and removing the foil placed thereon.

In the kit, according to the invention, the combination of pet food/snack gives the possibility to train and play with the animal anywhere, such as at home, in the park, or in the forest, with a toy inside the package such as a ball, tug, mouse, catnip ball and at the same time reward our animal for a job well done.

A portable kit containing two non-edible parts of the package can be containers of which one and the other can be used as a portable bowl for a pet's water intake.

A portable kit containing two non-edible parts of packaging can be containers of which one and the other can be used as a portable bowl for an edible product, snack, cream for a pet.

Kit containing pet food and a toy packaged in a non-edible portable container in the shape of an egg or other packaging capable of serving as a mobile feeding bowl.

In the meaning of the invention, the term “toy” also means other items such as a leash, collar, brush, pet medicine, paste, and a stick—a dental treat, which in the package according to the invention in combination with dog food—a snack will be a surprise.

A kit pursuant to an embodiment of the invention aims to make it easier for dog and cat owners to be able to train their pet and play with it anywhere by putting a toy for training and a food (pet snack) reward in one package. This is made possible by the universality of the product and the possibility to use one half of this pack in the shape of an egg or another as a food (pet snack) bowl or, for example, as a water bowl).

### Example 1

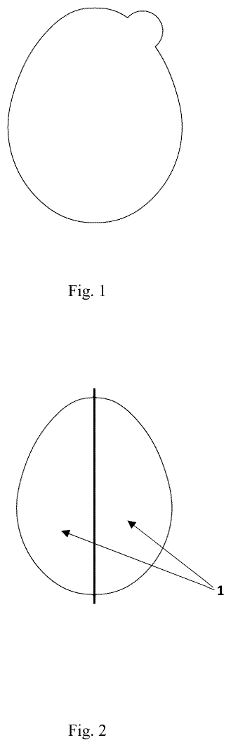

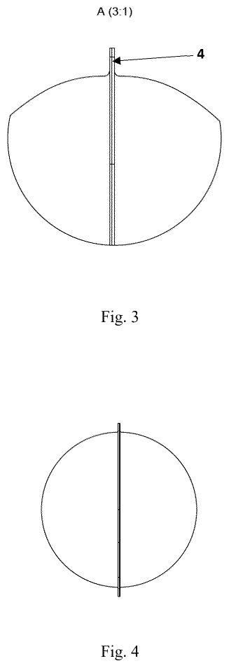

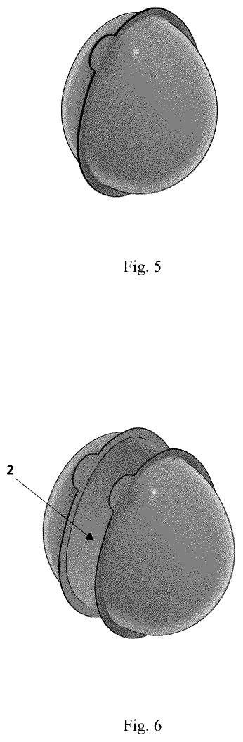

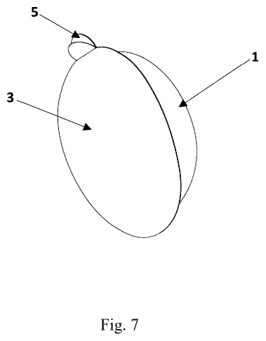

The kit for animals, according to the invention, is shown in FIG. 1-7, wherein 1 stands for housing, 2 stands for chamber, 3 stands for separating membrane, 4 stands for sealing flange, and 5 stands for tab.

In this exemplary embodiment, the kit, according to invention, consists of the package and a nutritional product located within said package. Said package consists of two-part housing 1, wherein both parts are mirror images of each other and together form essentially the shape of an egg (FIGS. 1-6) and are connected to each other face-to-face in a detachable manner (e.g. by adhesive bonding).

In this exemplary embodiment, the housing 1 is made entirely of a non-edible material for contact with food.

In this exemplary embodiment, inside the two-part housing 1 there is a chamber 2, which is divided into two compartments by separating membrane 3. Whereby, each of these two compartments constitutes a separate receptacle for a food product (e.g., food, treat) for an animal (e.g., dog, cat, rabbit or rodent) or a toy for an animal (e.g., leash, string), respectively.

In this exemplary embodiment, the separating membrane 3 is made of plastic. Wherein, each part of the housing 1 is provided with a sealing flange 4 with a tab 5 for opening or tearing the packaging of the set according to the invention.

Moreover, in this exemplary embodiment, the outer part of the package is covered with a printable material using available technologies.

### Example 2

A kit, as in example 1, except that the separating membrane 3 is made of edible material.

### Example 3

In this exemplary embodiment, the kit, according to the invention, consists of a package and a nutritional product and toy placed inside said package. Said package consists of two-part housing 1, wherein both parts are connected to each other face-to-face in a detachable manner (e.g., by adhesive bonding), and together, they form the shape of an egg. Whereby, inside the housing 1 there is one undivided chamber 2 containing both an animal food product and a toy.

1. A kit for animals comprising:
a first housing portion comprising a first exterior surface, a first interior surface and a first opening located opposite the first interior surface and at a first end of the first housing portion;
a second housing portion comprising a second exterior surface, a second interior surface and a second opening located opposite the second interior surface and at a first end of the second housing portion;
an edible animal nutritional product; and
an inedible animal toy,
wherein the first housing portion and the second housing portion are detachably coupled to one another forming a continuous chamber,
wherein the continuous chamber defines an entire interior volume of the kit,
wherein the continuous chamber is egg-shaped, and
wherein the edible animal nutritional product and the inedible animal toy are housed within the continuous chamber,
wherein the first end of the first housing portion and the second end of the second housing portion abut one another.

2. The kit of claim 1, wherein the first housing portion and the second housing portion are detachably coupled to one another by an adhesive bonding, the adhesive bonding forming a seal.

3. The kit according to claim 1, further comprising a removeable membrane affixed to one of the first housing portion at the first opening or the second housing portion at the second opening.

4. The kit of claim 3, wherein the removable membrane comprises an edible material.

5. The kit of claim 1, further comprising:
a first sealing flange at the first housing portion surrounding the first opening; and
a second sealing flange at the second housing portion surrounding the second opening,
wherein the first sealing flange and the second sealing flange are configured to align.

6. (canceled)

7. The kit of claim 5, further comprising:
a first tab positioned on an outer edge of the first sealing flange of the first housing portion and extending outward beyond the outer edge of the first sealing flange; and
a second tab position on an outer edge of the second sealing flange of the second housing portion and extending outward beyond the outer edge of the first sealing flange;
wherein the first tab and the second tab are aligned in the closed configuration.

8. (canceled)

9. The kit of claim 1, wherein the first exterior surface and the second exterior surface comprise an inedible material.

10. (canceled)

11. The kit of claim 1, wherein the first exterior surface and the second exterior surface is covered with a printable material.

12. The kit of claim 1, wherein the shape of the first housing portion and the shape of the second housing portion are mirror images of each other.

13. (canceled)

14. The kit of claim 3, wherein the removable membrane comprises a foil or configured to seal one of the first opening of the first housing portion and the second opening of the second housing portion.

15. (canceled)

16. The kit of claim 5, wherein the first flange and the second flange form an airtight seal in the closed configuration.

17. (canceled)

18. (canceled)

19. The kit of claim 1, wherein the animal nutritional product comprises one of a treat, an edible paste, or a liquid.

20. (canceled)

21. The kit of claim 1, wherein the edible animal nutritional product is housed entirely within the first housing portion, and the inedible animal toy is housed entirely within the second housing portion.
